(19) United States
(12) Patent Application Publication
(10) Pub. No.: US 2009/0126464 A1
(43) Pub. Date: May 21, 2009

(54) Acoustic Detector

(75) Inventors: Gena Perlov, Haifa (IL); Yoed Tsur, Kibbutz Mishmar Haemeq (IL)

Correspondence Address: Eckert Seamans Cherin & Mellott, LLC, U.S. Steel Tower, 600 Grant Street, 44th Floor, Pittsburgh, PA, 15219, US

(73) Assignee: Technion Research & Development Foundation Ltd., Haifa (IL)

(21) Appl. No.: 12/278,989

(22) PCT Filed: Feb. 12, 2007
(86) PCT No.: PCT/IL07/00189

§ 371 Date: Jan. 22, 2009

(30) Foreign Application Priority Data
Feb. 12, 2006 (IL) 173670

(51) Int. Cl. G01M 3/24

(52) U.S. Cl. 73/40.5 A

(57) ABSTRACT

An acoustic detector is described for detecting acoustic waves in a medium that can be a relatively dense medium. The detector comprises a concentrating structure provided with a lens-shaped cavity and an acoustic lens made of a dense fluid received within the cavity. A sensor is positioned at an acoustic focus distance from the acoustic lens. Sound waves propagating within the medium towards the acoustic detector are captured by the acoustic lens, concentrated through the concentrating structure, and are collected by the sensor. The acoustic detector can be applied to a vast variety of applications.

### FIELD OF THE INVENTION

The present invention relates to acoustic detectors. More particularly, the present invention relates to acoustic detector adapted to allow passive and active measurements of sound waves at a wide frequency range in dense bodies.

### BACKGROUND OF THE INVENTION

A sound wave, like any other wave, is introduced into a medium by a vibrating object. The vibrating object is the source, of the disturbance that moves through the medium. There are a number of devices used to detect sound. The most common are the ear and the microphone, which is a mechanical detector of sound. It has a membrane, that is made to vibrate by the sound. That vibration is converted into electrical signals that are then sent to a processor or electronic circuitry for amplification or such.

The medium through which the wave propagates is crucial to the performance of the devices. There are many applications in which the disturbance is made within a dense medium that inhibits or even prevents the ability to detect the sound wave that propagates within the medium.

One of the examples of a challenging medium that is difficult to handle is underground medium. Detecting sound waves that propagates through underground medium can provide industrial information as well as intelligence. As an example, undetected leaks from underground pipelines cost hundreds millions of dollars in environmental damage and lost product every year. Traditional technology to detect such leaks consists of expensive vehicle-based surveying methods, traveling the length of the pipeline to register emissions etc. Providing an efficient method and device for long-term leak monitoring of water, gas, and petroleum pipelines can present accurate information on the situation of the pipelines in every point through the pipes.

Attempts were made to solve the problem and one is disclosed in PCT patent application published as WO 2004/104104570 “ENHANCED ACOUSTIC DETECTION OF GAS LEAKS IN UNDERGROUND GAS PIPELINES” by Huebler et al. This application discloses a method for locating gas leaks from underground gas pipelines in which a first acoustic sensor having a first signal output is positioned in ground disposed substantially above or at a distance from the underground gas pipeline. At least one second acoustic sensor, having a second signal output is positioned in the ground at a plurality of locations substantially above the underground gas pipeline. The output signals from, the acoustic sensors are measured for each location of the second acoustic sensor and the signals are adaptively filtered to remove common noise signal components. The statistical minima of these rms voltages are determined for both the first output signal and the adaptively filtered second output signals and the differences determined. The location of the second acoustic sensor corresponding to the largest positive said difference is the location closest to the leak site. This solution is possible only in cases where the origin of disturbance is known, in this case, the detectors are positioned along the pathway of the pipelines which is a known factor.

There are many cases in which the origin of the disturbance is unknown and this is also a factor that has to be detected. Another example is tectonic underground movements that are highly needed to be detected too; however their direction and position is unknown.

Another application of the need in underground detection of disturbances is in intelligence work. Underground tunnels between countries are used in order to smuggle weapon's or other equipment or materials as well as people between the countries. There is a long felt need to detect in an efficient and, safe manner the activity involved in excavation of such tunnels.

Another example is a military example that involves detection of underground mines. This problem is addressed in U.S. Pat. No. 6,862,252 “Method and apparatus for acoustic detection of buried objects” filed in September 2003 by Hickling. This patent teaches a method and apparatus for acoustic detection, location and identification of a buried object using a source emitting bursts of sound that penetrate the ground and return echoes from the object to an array of acoustic vector probes located above the ground. Echoes recorded at the probes in the array, are converted to digital form and fed into a digital signal processor that computes the sound-intensity vector at each probe. Results are displayed on a computer screen or other device permitting an operator to interact with and control the apparatus. This method exhibits a solution for detecting objects that are relatively close to the ground.

### SUMMARY OF THE INVENTION

It is an object of the present invention to provide an acoustic detector that is adapted to monitor underground changes that could be due to natural changes, human illegal or military activity, or fault in underground systems.

It is another object of the present invention to provide an acoustic lens that has the ability to concentrate an acoustic sound wave to a relatively narrow area. A transducer placed in this, area can enhance a signal in accordance to laws in optical physics.

It is yet another object of the present invention to provide an acoustic lens that has the ability to transmit an acoustic sound wave from a sound transmitter to a certain direction.

It is thus provided in accordance with the present invention, an acoustic detector for detecting acoustic waves in a medium, the detector comprising:
a concentrating structure provided with a lens-shaped cavity;
acoustic lens made of a dense fluid received within said cavity;
a sensor positioned at an acoustic focus distance from said acoustic lens;

whereby sound waves propagating within the medium towards the acoustic detector are captured by said acoustic lens, concentrated through the concentrating structure, and are collected by said sensor.

Furthermore, in accordance with another preferred embodiment of the present invention, said acoustic lens is made of a material selected from a group of materials such as water, Teflon fluid, mercury.

Furthermore, in accordance with another preferred embodiment of the present invention, said concentrating structure is made of a material selected from a group of materials such as glass, composite concrete, ceramics or metals.

Furthermore, in accordance with another preferred embodiment of the present invention, the detector is further provided with, a material having acoustic impedance that is substantially similar to the acoustic impedance of the medium.

Furthermore, in accordance with another preferred embodiment of the present invention, said material is provided about said acoustic lens.

Furthermore, in accordance with another preferred embodiment of the present invention, said concentrating structure is rotatable about a rotational axis.

Furthermore, in accordance with another preferred embodiment of the present invention, said sensor is a piezoelectric device.

Furthermore, in accordance with another preferred embodiment of the present invention, a guide is further provided about said acoustic lens and is adapted to block waves coming from critical angles that can disturb the accuracy of a measurement.

Furthermore, in accordance with another preferred embodiment of the present invention, said guide is made of tungsten.

Furthermore, in accordance with another preferred embodiment of the present invention, said guide is manufactured as a circumferential ring positioned adjacent to said acoustic lens.

Furthermore, in accordance with another preferred embodiment of the present invention, information received by the detector is transferred to an electronic unit through wires.

Furthermore, in accordance with another preferred embodiment of the present invention, information received by the detector is transferred to an electronic unit in a wireless manner.

Furthermore, in accordance with another preferred embodiment of the present invention, the acoustic detector is provided within an underground cavity.

Furthermore, in accordance with another preferred embodiment of the present invention, said cavity is provided at an end of a vertical underground drill.

Furthermore, in accordance with another preferred embodiment of the present invention, a plurality of the acoustic detectors is provided along a predetermined line.

Furthermore, in accordance with another preferred embodiment of the present invention, a plurality of the acoustic detectors is provided along a predetermined structure.

Furthermore, in accordance with another preferred embodiment of the present invention, said predetermined structure is a cylinder.

Furthermore, in accordance with another preferred embodiment of the present invention, a plurality of the acoustic detectors is organized in a manner in which each detector is aimed at a different direction.

Furthermore, in accordance with another preferred embodiment of the present invention, said medium is a dense medium.

Furthermore, in accordance with another preferred embodiment of the present invention, the acoustic detector comprises a transmitter positioned adjacent to said sensor wherein said transmitter is adapted to transmit sound waves.

Additionally, in accordance with another preferred embodiment of the present invention, said sensor and said transmitter are both packed in one unit.

### BRIEF DESCRIPTION OF THE FIGURES

In order to better understand the present invention and appreciate its practical applications, the following Figures are attached and referenced herein. Like components are denoted by like reference numerals.

It should be noted that the figures are given as examples, and preferred embodiments only and in no way limit the scope of the present invention as defined in the appending Description and Claims.

FIG. 1 illustrates an underground acoustic detector in accordance with a preferred embodiment of the present invention.

FIG. 2 illustrates an acoustic lens to be used in an acoustic detector in accordance with, a preferred embodiment of the present invention.

FIG. 3 illustrates the results of angle sensitivity as tested using the acoustic detector reduced model shown in FIG. 3.

FIG. 4 illustrates a corner of a structure installed with three acoustic lenses in accordance with a preferred embodiment of the present invention.

FIG. 5 illustrates a set of acoustic lenses adapted for medical applications in accordance with a preferred embodiment of the present invention.

### DETAILED DESCRIPTION OF THE INVENTION AND FIGURES

The present invention provides a unique and novel acoustic detector adapted to be used in order to monitor disturbances in dense medium such as underground medium, walls, or physiological bodily mediums. The present invention is basically based on the physical principles according to which an acoustic lens is adapted to concentrate a front of an acoustic wave into a relatively small area. If a transducer is introduced in this specific area, an enhanced signal is achieved. The direction of the wave is changed according to Snell rule and the transmission of signal between mediums is

|T|²=4Z₁Z₂/(Z₁+Z₂)².

wherein Z is the acoustic impedance of the appropriate medium.

In cases of underground detection where the ground is made of sand or even porous ground and the lens is made of mercury, the transmission can be around 50%. In expected depths, the sound is being transmitted through the mediums in a detectable range.

The materials from which the detector is made, along with its special design, allow changing the direction without losing transmission. This enables, determining the direction of sound sources.

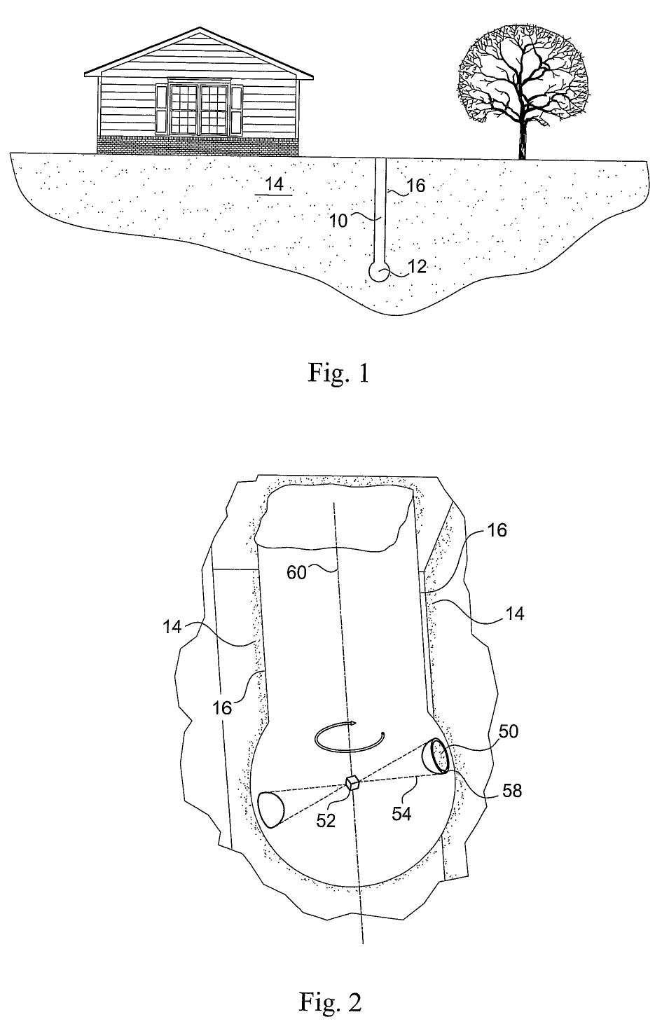

Reference is now made to FIG. 1 illustrating an underground acoustic detector in accordance with a preferred embodiment of the present invention. The embodiment shown herein is adapted to be used in application in which detection of underground disturbances is needed such as intelligence purposes.

The acoustic detector is placed within a drill 10 that is drilled in a predetermined position, underground. The bottom end of drill 10 is provided with a cavity 12 adapted to accommodate the detector. Medium 14 is the underground medium which is a part of the detector by acting as housing for the detector. Drill 10 is drilled to an appropriate depth while then a casing 16 is built on the internal walls of drill 10 as well as cavity 12. Casing 16 is made of a material having substantially the same transmission properties of medium 14 so as to prevent breaking the wave front when the wave propagates between the mediums.

The casing technology can utilize any technologies according to the type of casing used; for example metal alloy, composite concrete or composite polymers. It is expected that polymers having an acoustic impedance of about 3*10⁶ Kg/m²s is appropriate to be used as a casing in most grounds.

After drill 10 as well as cavity 12 are ready with casing 16 and a cavity 12 for the lens is established within the casing, the fluid part of the detector is inserted to within cavity 12, as will be explained herein after.

Reference is now made to FIG. 2 illustrating an acoustic lens to be used in an acoustic detector in accordance with, a preferred embodiment of the present invention. Acoustic lens 50 is inserted to within the detector's cavity facing medium 14 from one side. As mentioned herein before, casing 16 is being provided between acoustic lens 50 and medium 14 in order to coordinate the impedance between the casing and the medium. Lens 50 is preferably made of fluid with impedance as similar to the environment solids, and sound velocity as different as possible as compared to the surrounding solids. This fluid can be mercury, water, Teflon fluid or the like.

A sensor 52 that is preferably a piezoelectric device is connected to acoustic lens 50 through a concentrating structure 54 that can be made of glass or any other polymeric material, or composite concrete. The material from which structure 54 is made of provides an additional degree of freedom. Sensor 52 is positioned in a focal distance from the acoustic lens 50. The schematic illustration of the concentration of wave front is shown by a dashed line between the lens and the sensor.

It is optional to provide a means adapted to block any waves propagating to the sensor from directions other than the lens.

The shape of acoustic lens 50 is determined according to the relative sound velocities between the material from which the lens is made of and the material from which the surrounding mediums are made of. The lens can be made as a concave or convex lens according to the expected conditions:

A guide 58 adapted to block waves coming from critical angles that can disturb the accuracy of the measurement is provided about acoustic lens 50. The guide is preferably made of tungsten. Guide 58 can be manufactured as a circumferential ring positioned adjacent to acoustic lens 50.

Line 60 is a rotation line about which acoustic lens 50 is rotated in order to acquire sound waves from all different directions especially in cases the origin of sound waves is unknown.

The information collected by the sensor can be transferred to computer by wiring means or using known wireless means.

The information detected using the acoustic lens of the present invention can be processed by a processor wherein the data is transmitted in a wire or wireless manner to the processor or to any other electronic device that is adapted to illustrate the results in a visual manner.

As mentioned herein before, there are many applications in which the acoustic detector of the present invention can be utilized. Civilian and military detection of underground activity such as excavation of tunnels can be detected. The civilian use can offer security solutions such as surveillance of any undesired digging around jail houses, banks, pharmacy shops, etc. and in the military field, detection of underground tunnels being excavated in around the borders between countries.

According to the embodiment showed herein before, a prototype was built and tested. The acoustic detector was designed to be within a tube of about 1 meter long. A sensor, which is a piezoelectric film, was adhered by epoxy glue to a concrete block within the tube. The tube was filed with concrete while at the open upper end of the tube; the concrete was polished to a shape that eventually will determine the shape of the lens. The diameter of the tube and the lens was about 40 cm. A cover made of concrete shaped as a cylinder was placed on the open upper end of the tube adjacently to the lens shape so that a gap shaped as a lens is formed between the open end of the tube and the cover. Water was received by the gap through tubes. Some adjustments between the wave velocities of the different mediums that are in contact with the lens was performed by using a graduating change between concrete with small amounts of sand and concrete having high content of sand.

The lens was buried in sand one meter below the surface. The ability of the acoustic detector to sense a usable signal was tested through several parameters as follows:

1. separation of signal from noise.
2. enhancement of a signal.
3. the source of enhancement.
4. sensitivity of the detector to the angle from which the signal is advancing.

The main results are as follows: a noise is present at all times within the sand, probably due to a generator operated in the area. A signal is generated by an iron weight that falls on an iron surface placed on the sand. Using a simple algorithm, a signal to noise ratio of factor 5-10 was received.

For testing whether the signal is being enhanced by the lens, as theory dictates, some experiments were done while the gap shaped as a lens was not filed with water. This formed effectively a dispersed lens. There was a significant reduction in the measured signal, indicating the condensing lens is indeed enhancing the signal.

It was also established that the signal is not enhanced due to the iron tube that covers the concrete or a waveguide that shapes the apparatus. Experiments done with signals from the rare (without lens) side of the apparatus have shown that the enhancement of the signal is a result of the lens.

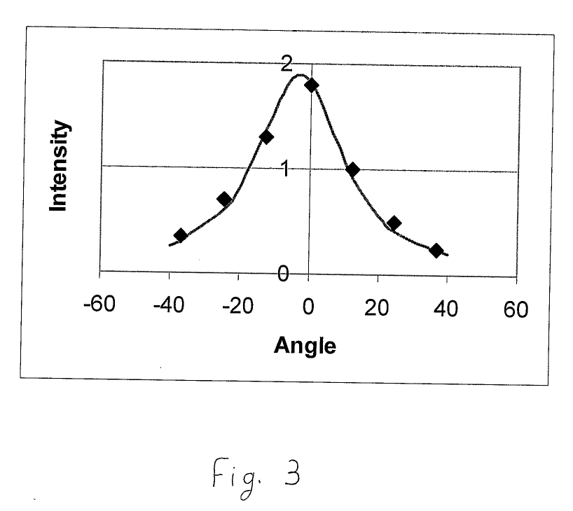

As mentioned, the sensitivity of the detector to the angle from which the signal is advancing was also tested. The results are shown in FIG. 3. The graph depicts the intensity of the signal as a function of the angle from which the signal is advancing. The intensity units are based on a detector that is directly buried in sand and establishes a signal of intensity value of 1. The points are the results of the measurements and the line is a Lorentzian corresponding curve. Theoretically, the voice intensity of a planar sound wave that advances perpendicularly to the detector is converged by the lens to an area in which the sensor is placed. In the tested case, the wave sound was formed on the surface of the sand (one meter above the detector) and in a distance of 140 cm from it. That means that the wave is not a planar wave and is not perpendicular to the detector; however, the waves were enhanced when the detector was directed toward the source of the signal. Signals advancing from angles that are more than 15 degrees were significantly reduced. Moreover, as shown from FIG. 3, the peak of the curve allows angle resolution of single degrees.

It should be noted that the tests were made using an embodiment that was made from simple and available materials and the performance of the acoustic detector of the present invention can be significantly increased using other materials having better physical characteristics that are consistent with the requirements of such detector. It should be also mentioned that the embodiment shown herein was designed solely for testing and by no means limits the scope of the present invention.

One of the applications for which the acoustic lens of the present invention can be utilized is for sensing vibrations in structures such as buildings.

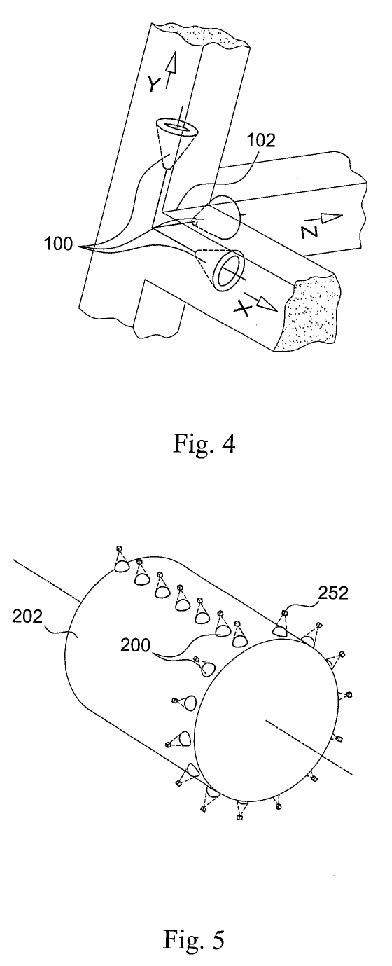

Reference is now made to FIG. 4 illustrating a corner of a structure installed with three acoustic lenses in accordance with a preferred embodiment of the present invention. Each acoustic lens is similar in its structure to the lens shown herein before. Lenses 100 are adhered or attached in any other way to a corner 102 of a structure such as a cube or a junction of bars while organized in a manner representing 3 normal vectors. This is due to the fact that the longitudinal waves are propagating in a predetermined direction. Lenses 100 are used solely for the measurement purpose and therefore are held adjacent to corner 102 by conventional means such as magnetic means, adherence, etc.

It is optional to provide the acoustic detector with wave source means that is adapted to generate sound waves in the area of the sensor so as to generate, acoustic signals and transmit them through the lens, in particular, the lens can act as an acoustic projector, to send concentrated packets of waves towards a preferred direction.

According to the preferred embodiment of the present invention, while the structure is being built or tested, any acoustic waves performed by cracks or instabilities that are present in the structure will be collected by acoustic lenses 100. In accordance with the specific lens or lenses in which the waves had been acquired, the direction from which, the waves propagate can be established. The structures that can be secured and measured are buildings, bridges, or landing runways in airports etc.

Regarding to runways, the acoustic lens or an array of acoustic lenses can be provided along the runway sides in airports in order to detect an approaching airplane, and especially on the runway touchdown zone in order to sense a landing airplane and to detect any irregularities in its wheels.

Similarly, as for military applications, launching of rackets or other aerial bombs can be detected in a similar manner.

An additional and very important application is the physiological acoustometric application. A set of acoustic detectors as claimed in the present invention can be utilized for mapping acoustic origins in the body so as to detect flow disturbances, pace disturbances or disturbances in the tendons. Positioning of a plurality of detectors can provide the ability to perform scanning activity in cross sections. In addition, the use of such acoustic lenses can provide additional information in ultrasonic applications. An array of detectors can be placed on the body without additional force and without acoustic fluid lenses and increasing the resolutions of the measurements.

Reference is now made to FIG. 5 illustrating a set of acoustic lenses adapted for medical applications in accordance with a preferred embodiment of the present invention. A plurality of acoustic lenses 200 are adhered, on a cylindrical bulk 202 that can act as detector for detecting and measuring differences in blood flow in veins or arteries. Acoustic lenses 200 can be organized on cylindrical bulk in any manner that suits the necessary outcome; in this case, the acoustic lenses are organized about the circumference of the cylindrical bulk and along its length. Any other shape instead of the cylinder shape can be used without limiting the scope of the present invention. The cylindrical bulk is adhered on the body part on which the detection is to be carries out. Any adherence means can be used in the art while there is no need for an expensive mechanical supporting system.

Optionally, as mentioned before, addition of acoustic generators to the acoustic lens besides the sensor can form a sound wave transmitter and receiver. Therefore, sound waves can be measured and transmitted using the same lenses or one can form a set of transmitters and a set of receivers.

Another obvious application that was already mentioned is the detection of leaks in underground pipelines, an application that can save companies and other entities huge amounts of money as well as preventing environmental damage in case of damaging fluid.

Another application among others is the development of a seismic detector that can be used for monitoring earthquakes.

In another application where the acoustic lenses are used as wave generators, shock waves can be generated in order to form from different sides shear forces for breakdown of a common point.

It should be clear that the description of the embodiments and attached Figures set forth in this specification serves only for a better understanding of the invention, without limiting its scope as covered by the following Claims:

It should also be clear that a person skilled in the art, after reading the present specification can make adjustments or amendments to the attached Figures and above described embodiments that would still be covered by the following Claims.

1. An acoustic detector for detecting acoustic waves in a medium, the detector comprising:
a concentrating structure provided with a lens-shaped cavity;
acoustic lens made of a dense fluid received within said cavity; and
a sensor positioned at an acoustic focus distance from said acoustic lens,
whereby sound waves propagating within the medium towards the acoustic detector are captured by said acoustic lens, are concentrated through the concentrating structure, and are collected by said sensor.

2. The acoustic detector as claimed in claim 1, wherein said acoustic lens is made of a material selected from the group of consisting of water, Teflon fluid, and mercury.

3. The acoustic detector as claimed in claim 1, wherein said concentrating structure is made of a material selected from the group consisting of glass, composite concrete, ceramics, and metals.

4. The acoustic detector as claimed in claim 1, wherein the detector is further provided with a material having an acoustic impedance that is substantially similar to the acoustic impedance of the medium.

5. The acoustic detector as claimed in claim 4, wherein said material is provided about said acoustic lens.

6. The acoustic detector as claimed in claim 1, wherein said concentrating structure is rotatable about a rotational axis.

7. The acoustic detector as claimed in claim 1, wherein said sensor is a piezoelectric device.

8. The acoustic detector as claimed in claim 1, wherein a guide is further provided about said acoustic lens and is adapted to block waves coming from critical angles that can disturb the accuracy of a measurement.

9. The acoustic detector as claimed in claim 8, wherein said guide is made of tungsten.

10. The acoustic detector as claimed in claim 8, wherein said guide is manufactured as a circumferential ring positioned adjacent to said acoustic lens.

11. The acoustic detector as claimed in claim 1, wherein information received by the detector is transferred to an electronic unit through wires.

12. The acoustic detector as claimed in claim 1, wherein information received by the detector is transferred to an electronic unit in a wireless manner.

13. The acoustic detector as claimed in claim 1, wherein the acoustic detector is provided within an underground cavity.

14. The acoustic detector as claimed in claim 13, wherein said cavity is provided at an end of a vertical underground drill.

15. The acoustic detector as claimed in claim 1, wherein a plurality of the acoustic detectors is provided along a predetermined line.

16. The acoustic detector as claimed in claim 1, wherein a plurality of the acoustic detectors is provided along a predetermined structure.

17. The acoustic detector as claimed in claim 16, wherein said predetermined structure is a cylinder.

18. The acoustic detector as claimed in claim 16, wherein a plurality of the acoustic detectors is organized in a manner in which each detector is aimed at a different direction.

19. The acoustic detector as claimed in claim 1, wherein said medium is a dense medium.

20. The acoustic detector as claimed in claim 1, further comprising a transmitter positioned adjacent to said sensor wherein said transmitter is adapted to transmit sound waves.

21. The acoustic detector as claimed in claim 20, wherein said sensor and said transmitter are packed in one unit.

22. (canceled)
